(19) United States
(12) Patent Application Publication
(10) Pub. No.: US 2010/0080608 A1
(43) Pub. Date: Apr. 1, 2010

(54) DEVELOPING DEVICE AND IMAGE FORMING APPARATUS INCLUDING THE SAME

(75) Inventor: Kenichi Mukai, Osaka (JP)

Correspondence Address: FROMMER LAWRENCE & HAUG, 745 FIFTH AVENUE- 10TH FL., NEW YORK, NY, 10151, US

(73) Assignee: KYOCERA MITA CORPORATION, Osaka (JP)

(21) Appl. No.: 12/497,215

(22) Filed: Jul. 2, 2009

(30) Foreign Application Priority Data
Sep. 29, 2008 (JP) 2008-251090

(51) Int. Cl. G03G 15/09

(52) U.S. Cl. 399/104; 399/274

(57) ABSTRACT

An embodiment of a developing device may include a housing, magnetic developer, and a developer bearing member. In some embodiments, the developer bearing member may include a magnet member. The magnet member may allow the developer to remain in the housing. A developer regulating member may be positioned proximate the developer bearing member and have one or more cut portions. In some embodiments, the cut portions may be positioned at each end of the developer regulating member in a surface facing the developer bearing member. The developer regulating member may regulate an amount of the developer held on the developer bearing member. A magnetic sealing member may extend along an outer peripheral surface of the developer bearing member at each end and may be positioned proximate the cut portion. In some embodiments, a portion of the magnetic sealing member may be positioned within the cut portion.

### INCORPORATION BY REFERENCE

This application is based upon and claims the benefit of priority from the corresponding Japanese Patent application No. 2008-251090, filed Sep. 29, 2008, the entire content of which is incorporated herein by reference.

### FIELD OF THE INVENTION

The present invention relates to an image forming apparatus, such as a copy machine, a facsimile machine, and a printer, and a developing device included in the image forming apparatus.

### BACKGROUND OF THE INVENTION

In general, developer powder is mainly used in an electrophotographic image forming apparatus, such as a copy machine, a printer, and a facsimile machine. An electrostatic latent image may be formed on an image bearing member, such as a photosensitive drum. Developer may be used to coat the image bearing member to form a toner image. The toner image is then transferred onto a recording medium, such as paper. A fixing process may be performed to fix the image to the recording medium.

Developer can be broadly classified into a multi-component developer, a two-component developer may include toner and carrier, and a single-component developer may include magnetic toner. A developer regulating member such as a regulating blade, is provided to promote frictional electrification of the developer on a developer bearing member. The developer regulating member may be formed only of a magnetic member. Alternatively, the developer regulating member may include a non-magnetic member as a base member and a magnetic member disposed in an area (e.g., developer regulating area) where the magnetic member faces the developer bearing member.

In a developing device including the above-described developer regulating member, a part of the developer supplied to the developer regulating area passes through the developer regulating member and forms a developer layer on the developer bearing member as the developer bearing member rotates. However, most of the developer supplied to the developer regulating area is blocked by the developer regulating member and is returned to the inside of the developing device. At this time, the developer blocked by the developer regulating member, tends to move toward the ends of the developer bearing member and the developer regulating member in the longitudinal direction thereof. Therefore, it is necessary to prevent the developer from leaking from the developing device at the ends of the developer bearing member and the developer regulating member.

Accordingly, a method for inhibiting leakage of the developer by providing a magnetic sealing member at each end of the developing device in the longitudinal direction thereof has been proposed. According to this method, the leakage of the developer is prevented by using a magnetic brush formed between the magnetic sealing member and the developer bearing member due to a magnetic field between a magnet poles disposed in the developer bearing member and the magnetic sealing member.

The leakage of developer has been prevented using only a magnetic sealing member. As is shown in FIG. 1, depicting a developing device, a magnetic sealing member 101 is fixed to an inner surface of a housing of the developing device at each end prior to use. Thus, the structure is designed such that a gap G2 is provided between the magnetic sealing member 101 and a developer regulating member 104, so that the magnetic sealing member 101 does not interfere with the developer regulating member 104 in the process of attaching the developer regulating member 104. However, in this structure, the direction in which the developer moves from a central area of the developer bearing member to the end thereof (direction shown by the arrow B) coincides with the direction in which the gap G2 extends. Therefore, even if the gap G2 is filled with a magnetic brush formed between the magnetic sealing member 101 and the developer bearing member, the developer easily leaks through the gap G2.

The leakage of the toner at the ends of the developer bearing member can also be prevented by placing a spacer which fills a gap between a developing roller and an end sealing member at each end of the developer bearing member. Therefore, also in the structure including the magnetic sealing member, an auxiliary sealing member (spacer) made of sponge-like elastic body, nonwoven fabric, etc., may be additionally used to prevent the leakage of the developer through a space between an end face of the developer regulating member and a contact surface of the magnetic sealing member. Such a structure is shown in FIG. 2.

Referring to FIG. 2, a magnetic sealing member 101 is positioned upstream of a position where a developer bearing member 102 and a developer regulating member 104 face each other in a rotational direction of the developer bearing member 102 (direction shown by the arrow A). A magnet member 103 having a plurality of magnet poles is disposed in the developer bearing member 102. An auxiliary sealing member 105 made of, for example, sponge, is wound around the developer regulating member 104. An end portion of the magnetic sealing member 101 in the longitudinal direction thereof is in contact with the auxiliary sealing member 105, so that the leakage of the developer through the gap between the magnetic sealing member 101 and the developer regulating member 104 is prevented.

As shown in FIG. 3, an auxiliary sealing member 105 will be attached at a position displaced toward the inside of the developing device (toward the front in FIG. 3). In such a case, the developer which moves along the longitudinal direction of the developer bearing member 102 in the direction shown by the arrow B from the central area of the developer bearing member 102 toward the end thereof is blocked by the magnetic sealing member 101, and the developer which flows downstream in the rotational direction of the developer bearing member 102 (direction shown by the arrow A) due to the rotation of the developer bearing member 102 is blocked by the auxiliary sealing member 105. Therefore, a large load is applied to the auxiliary sealing member 105, and the life of the auxiliary sealing member 105 is considerably reduced. To prevent this, the auxiliary sealing member 105 must be attached with high accuracy. Therefore, the assembly process of the developing device is complex and difficult.

The leakage of the developer may also be prevented by a method using only the magnetic sealing member. In this method, a magnetic member is disposed on a non-contact surface of an elastic developer regulating member, and a magnet is disposed on a portion of a developer container which faces the elastic developer regulating member such that the magnet is spaced from the magnetic member by a predetermined distance, so that a magnetic brush is also formed between the developer container and the elastic developer regulating member.

### SUMMARY OF THE INVENTION

An embodiment of a developing device may include, but is not limited to: a housing, a developer bearing member, a developer regulating member, and/or a magnetic sealing member.

In some embodiments, the housing may house a developer. The developer may include, but is not limited to magnetic developer such as a single-component magnetic developer, a two-component developer, for example, a developer including a toner component and magnetic carrier, a multi-component developer or mixtures thereof.

Some housing embodiments may provide support to the developer bearing member. For example, the developer bearing member may be supported by the housing in a manner which allows the developer bearing member to rotate. In an embodiment, a magnet member disposed in the developer bearing member may allow the developer to remain in the developer bearing member.

In some embodiments a developer regulating member may be positioned proximate a developer bearing member. The developer regulating member may be positioned such that it is substantially parallel to the developer bearing member. In an embodiment, a developer regulating member may include a cut portion (e.g., notch) at each end. Some embodiments of the developer regulating member may include one or more cut portions. Cut portions may be positioned in a surface of the developer regulating member proximate the developer bearing member. In some embodiments, the developer regulating member may regulate an amount of developer held on the developer bearing member.

Some embodiments may include a magnetic sealing member which extends along an outer peripheral surface of the developer bearing member at each end of the developer bearing member in the longitudinal direction. Further, the developer bearing member may extend to come in contact with the cut portion from an upstream side in a rotational direction of the developer bearing member.

Other objects and advantages of the present invention will become apparent from the following description of the embodiment.

The above and other objects, features, and advantages of the present invention will be more apparent from the following detailed description of preferred embodiments taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a sectional perspective view of a section around an end of a developer regulating member included in a developing device according to the prior art from the inside of the developing device.

FIG. 2 is a sectional view illustrating the structure in which an auxiliary sealing member is disposed in a space between a magnetic sealing member and the developer regulating member in the developing device according to the prior art.

FIG. 3 is a sectional perspective view of a section around an end of the developer regulating member shown in FIG. 2 viewed from the inside of the developing device.

FIG. 4 is a schematic sectional view of an image forming apparatus including a developing device according to the present invention.

FIG. 5 is a sectional side view of the developing device according to the embodiment of the present invention.

FIG. 6 is a sectional view of a developer bearing member and a developer regulating member included in the developing device according to the embodiment of the present invention at one end of the developing device in the longitudinal direction thereof.

FIG. 7 is a sectional perspective view of a section around an end of the developer regulating member included in the developing device according to the embodiment of the present invention viewed from the inside of the developing device.

FIG. 8 is an enlarged view of a section around an end of a magnetic sealing member shown in FIG. 7.

FIG. 9 is a plan view of the structure around a cut portion in the developing device according to the embodiment of the present invention, viewed from the magnetic sealing member.

FIG. 10 is an enlarged view of a section around an end of a magnetic sealing member.

FIG. 11 is an enlarged view of a section around an end of a magnetic sealing member.

FIG. 12 is an enlarged view of a section around an end of a magnetic sealing member.

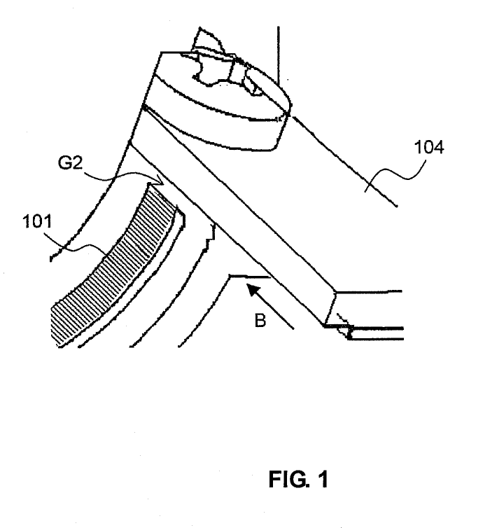

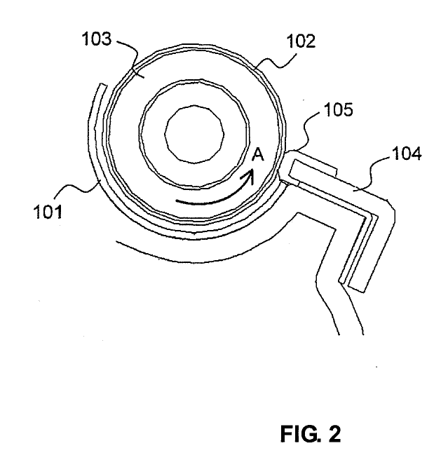

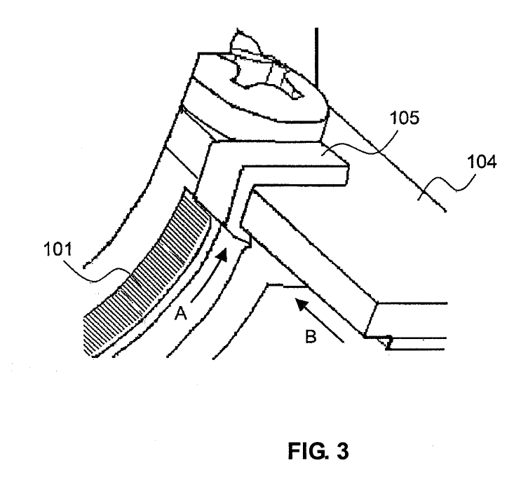

### DETAILED DESCRIPTION OF THE EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents.

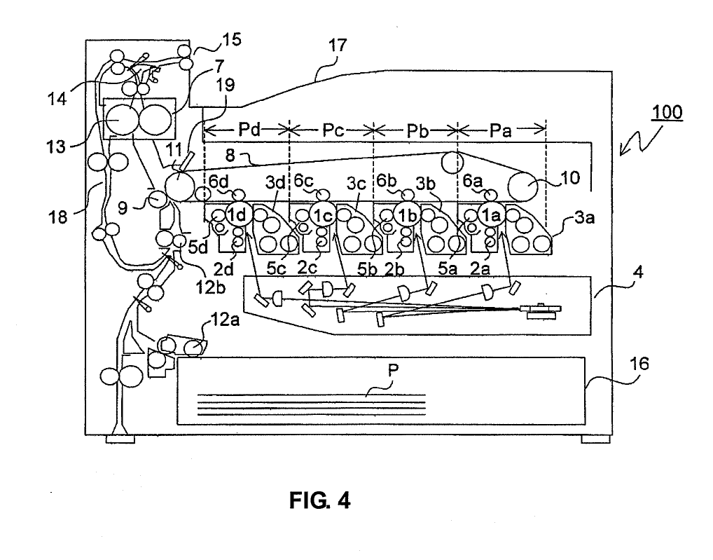

An embodiment of the present invention will be described with reference to the drawings. FIG. 4 is a schematic sectional view of an image forming apparatus including a developing unit. In the present embodiment, color image forming apparatus 100 will be described. An image forming apparatus may include tandem operation. For example, an embodiment may include utilizing multiple colors in a color image forming apparatus in succession. Thus, an embodiment of a color image forming apparatus may include one or more image forming sections. In an embodiment, each image forming section may correspond to a different color. For example, an imaging forming apparatus may have multiple image forming sections each corresponding to a different color. These color images may be transferred to a recording medium. Recording media may include, but are not limited to paper, transparencies, labels, transfer sheets and/or any other media known in the art.

As shown in FIG. 4, color image forming apparatus 100 includes four image forming sections Pa, Pb, Pc, and Pd, positioned in order from the upstream side (right side in FIG. 4) in the direction of the conveyance of the recording medium (e.g., a sheet of paper). The image forming sections Pa to Pd may correspond to four different colors (e.g., cyan, magenta, yellow, and black). Thus, utilizing the positioning shown in FIG. 4, the color images may be transferred successively. For example, a cyan image, a magenta image, a yellow image, and a black image may be formed successively on the recording medium. Thus, an image may be formed by performing a charging step, an exposure step, a developing step, and a transfer step. In some embodiments, the order of the color images formed may vary. In addition, the colors utilized may vary.

The image forming sections Pa to Pd include photosensitive drums 1a, 1b, 1c, and 1d, respectively, on which visual images (e.g., toner images) of the respective colors may be formed. The toner images formed on the photosensitive drums 1a to 1d are successively transferred onto intermediate transfer belt 8, which is rotated clockwise in FIG. 4 by a driver (not shown) so as to move through positions adjacent to the image forming sections. Then, the toner images may be simultaneously transferred onto a recording medium P by secondary transfer roller 9, and fixed on the recording medium P by fixing unit 7. Then, the recording medium P may be ejected from the main body of the apparatus. An image forming process may be performed for each of the photosensitive drums 1a to 1d while the photosensitive drums 1a to 1d are rotated counterclockwise in FIG. 4.

The recording medium P onto which the toner images are transferred may be stored in paper cassette 16 disposed in a lower section of the apparatus, and may be conveyed to secondary transfer roller 9 through paper feed roller 12a and a pair of registration rollers 12b. In some embodiments, a sheet made of dielectric resin may be used as the intermediate transfer belt 8. The intermediate transfer belt 8 may be an endless belt obtained by overlapping end portions of the sheet, or a seamless belt which has no seams. In addition, a blade-shaped belt cleaner 19 for removing the toner which remains on the surface of intermediate transfer belt 8 is disposed at a position downstream of secondary transfer roller 9.

In some embodiments, an apparatus may include multiple image forming sections Pa, Pb, Pc and Pd. Corresponding charging devices 2a, 2b, 2c, and 2d may charge the photosensitive drums 1a to 1d, respectively. Further, an exposure unit 4 may subject the photosensitive drums 1a to 1d to an exposure process based on image information. In addition, corresponding developing units 3a, 3b, 3c, and 3d may form toner images on the photosensitive drums 1a to 1d, respectively. Finally, cleaning units 5a, 5b, 5c, and 5d may be used to remove developer (toner) which remains on the photosensitive drums 1a to 1d, respectively. The charging devices, developing units, and/or cleaning units may be positioned in areas around the rotatable photosensitive drums 1a to 1d and/or below photosensitive drums 1a to 1d.

In some embodiments, a user may input a command for starting an image forming operation. Charging devices 2a to 2d may uniformly charge the surfaces of photosensitive drums 1a to 1d, respectively. Then, the surfaces of photosensitive drums 1a to 1d may be irradiated with light by exposure unit 4, so that electrostatic latent images corresponding to image signals form on photosensitive drums 1a to 1d. Developing units 3a to 3d may be filled with predetermined amounts of cyan, magenta, yellow, and black toners supplied by toner supplying devices (not shown). In some embodiments, the toners in different colors are supplied to photosensitive drums 1a to 1d by developing units 3a to 3d, respectively. The toners may electrostatically adhere to photosensitive drums 1a to 1d. Thus, toner images corresponding to the electrostatic latent images formed by the exposure process performed by the exposure unit 4 may be formed on the photosensitive drums 1a to 1d.

In some embodiments, an electric field may be applied to intermediate transfer belt 8 at a predetermined transfer voltage, and the cyan, magenta, yellow, and black toner images formed on the photosensitive drums 1a to 1d are transferred onto the intermediate transfer belt 8 by intermediate transfer rollers 6a, 6b, 6c, and 6d, respectively. The four images in different colors may be formed in a predetermined positional relationship so that a full-color image may be formed from the four images. Toner remaining on the surfaces of the photosensitive drums 1a to 1d may be removed by the cleaning units 5a to 5d, so that the next electrostatic latent images may be continuously formed.

In an embodiment, intermediate transfer belt 8 may be stretched between a conveying roller 10 and a driving roller 11. The driving roller 11 may be rotated by a driving motor (not shown), and intermediate transfer belt 8 may be rotated clockwise by the rotation of the driving roller 11. In some embodiments, when the intermediate transfer belt 8 starts to rotate clockwise, the recording medium P may be conveyed from registration rollers 12b to secondary transfer roller 9 positioned adjacent to intermediate transfer belt 8 at a predetermined timing. Then, a full-color image may be transferred onto the recording medium P. The recording medium P on which the full-color toner image is transferred may be conveyed to fixing unit 7.

In some embodiments, recording medium P conveyed to the fixing unit 7 may be heated and pressurized by a pair of fixing rollers 13, so that the toner image on the surface of the recording medium P is fixed. Thus, a predetermined full-color image may be formed on the recording medium P. The direction in which the recording medium P having the full-color image formed thereon is conveyed is switched between a plurality of directions by branching unit 14. In the case where the image is to be formed on only one side of the recording medium P, the recording medium P is ejected onto an ejection tray 17 by ejection rollers 15.

In some embodiments, images may be formed on both sides of recording medium. Images may be formed on both sides of the recording medium P by passing recording medium P through the fixing unit 7 and branching unit 14 toward sheet conveying path 18. Then, recording medium P is reversed and is conveyed to the secondary transfer roller 9 again. The next image that is formed on the intermediate transfer belt 8 is transferred by the secondary transfer roller 9 onto the side of recording medium P where no image is formed. Then, the recording medium P is conveyed to the fixing unit 7, where the toner image on the recording medium P is fixed. Finally, the recording medium P is ejected onto ejection tray 17.

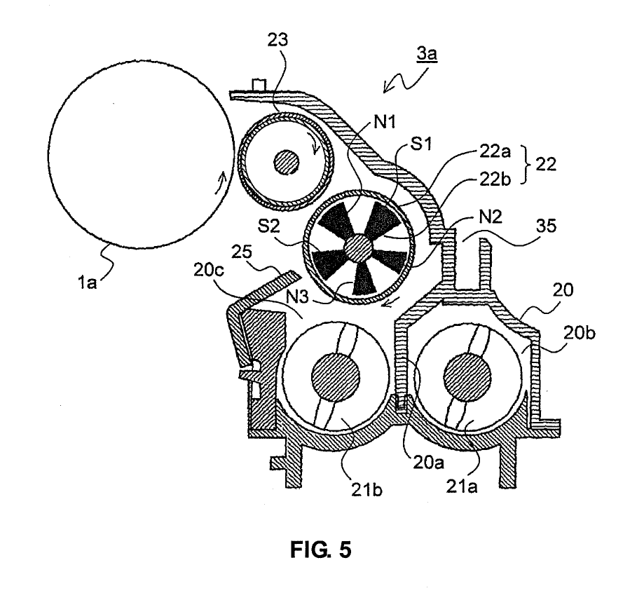

FIG. 5 is a sectional side view illustrating the structure of the developing unit according to the present invention. Here, the developing unit 3a included in the image forming section P as shown in FIG. 4 will be described. The structures of the developing units 3b to 3d included in the image forming sections Pb to Pd, respectively, are similar to the structure of the developing unit 3a, and explanations thereof are thus omitted.

As shown in FIG. 5, the developing unit 3a includes developer container 20 which contains two-component developer (hereinafter referred to simply as developer). Developer container 20 is sectioned into first and second mixing chambers 20b and 20c by a partition wall 20a. A first mixing screw 21a and a second mixing screw 21b are rotatably disposed in the first and second mixing chambers 20b and 20c, respectively. Mixing screws 21a and 21b mix toner (positively charged toner) supplied from a toner container (not shown) with carrier to charge the toner.

Mixing screws 21a and 21b convey the developer in an axial direction thereof while mixing the developer, and the developer circulates between the first and second mixing chambers 20b and 20c through developer passages (not shown) formed in the partition wall 20a. In the example shown in the FIG. 5, the developer container 20 extends toward the upper left, and a developer bearing member (e.g., magnet roller) 22 is disposed above mixing screw 21b in the developer container 20. In addition, a developing roller 23 is disposed so as to face the developer bearing member 22 at an upper left position thereof. In some embodiments, the configurations of these parts may vary. Developing roller 23 faces the photosensitive drum 1a at an open side (left side in FIG. 5) of developer container 20. Developer bearing member 22 and developing roller 23 rotate clockwise in FIG. 5.

Some embodiments may include a toner sensor (not shown) disposed in the developer container 20 such that the toner sensor faces the first mixing screw 21a. A toner sensor may control an amount of toner provided to the developer container. For example, the toner may be supplied to the developer container 20 through toner supply port 35 from the toner container (not shown) in accordance with the toner density detected by the toner sensor.

As is shown in FIG. 5, developer bearing member 22 includes non-magnetic rotating sleeve 22a and a magnet member 22b which is disposed in the rotating sleeve 22a and which includes a plurality of magnet poles. Further, the magnet member 22b may be provided with five magnet poles including three N poles (N1 to N3 poles) and two S poles (S1 and S2 poles). In some embodiments, the magnet poles may be arranged along the rotational direction of the rotating sleeve. For example, as depicted in FIG. 5 the magnet poles are arranged along the rotational direction of the rotating sleeve 22a such that the S1 pole is disposed between the N1 and N2 poles and the S2 pole is disposed between the N3 and N1 poles. In alternate embodiments, the configurations of the magnet poles on the magnet member may vary. For example, the number of magnet poles used may vary. In addition, some embodiments may include an alternate arrangement of the north and south poles.

Developing roller 23 may include a non-magnetic rotating sleeve, and faces rotating sleeve 22a of developer bearing member 22 such that a predetermined gap is provided therebetween. As shown in FIG. 5, developing roller 23 faces the N1 pole with a predetermined gap therebetween.

In addition, some embodiments may include developer regulating member 25 attached to the developer container 20 such that the developer regulating member 25 extends in the longitudinal direction (an axial direction) of the rotating sleeve 22a (direction perpendicular to the page in FIG. 5). Developer regulating member 25 is positioned upstream of the position at which developing roller 23 and developer bearing member 22 face each other in the rotational direction of rotating sleeve 22a (clockwise direction in FIG. 5). A small space (gap) may be provided between an end portion of the developer regulating member 25 and the surface of the rotating sleeve 22a.

In an embodiment, a predetermined direct-current voltage and a predetermined alternating-current voltage may be applied to the developer bearing member 22 and the developing roller 23. As described above, the first mixing screw 21a and the second mixing screw 21b cause the developer to circulate in the developer container 20 while mixing the developer to charge the toner, and the developer is conveyed to the developer bearing member 22 by the second mixing screw 21b. In some embodiments, a magnetic brush (not shown) may be formed on the developer bearing member 22. The layer thickness of the magnetic brush on the developer bearing member 22 may be regulated by the developer regulating member 25. As a result, a thin toner layer may be transferred from the developer bearing member to the developing roller. This transfer may occur in accordance with the potential difference between the developer bearing member developer bearing member 22 and the developing roller 23. For example, the potential difference between the magnetic field between the N1 pole and the developing roller 23 may allow the transfer from the developer bearing member to the developing roller. Then, the thin toner layer formed on the developing roller 23 may be transferred to the photosensitive drum 1a as an electrostatic latent image.

An embodiment may include a method for regulating an amount of developer provided on the developer bearing member 22. The method will be described in detail with reference to FIG. 5. As shown in FIG. 5, developer regulating member 25 faces the S2 pole. Therefore, if developer regulating member 25 is made of a magnetic body, an attractive magnetic field may be generated between the end of the developer regulating member 25 and the rotating sleeve 22a. A magnetic body may be formed from any material that responds to a magnetic field including, but not limited to magnetic stainless steel.

Due to this magnetic field, the developer may be formed into a brush-like shape which extends between developer regulating member 25 and rotating sleeve 22a. Thus, a magnetic brush may be formed. Then, when the rotating sleeve 22a rotates clockwise and the magnetic brush reaches a position at which the rotating sleeve 22a faces the developing roller 23, the magnetic brush comes into contact with the surface of the developing roller 23 at a position between the N1 pole and the developing roller 23. In some embodiments, due to the electric field applied between the rollers, the magnetic brush forms a thin toner layer on the surface of the developing roller 23.

When the rotating sleeve 22a further rotates, a repulsive magnetic field is applied by the N2 pole and the N3 pole. Thus, the developer is removed from rotating sleeve 22a in developer container 20. The developer is mixed and conveyed by the second mixing screw 21b, and is attracted to the rotating sleeve 22a again by the magnetic field generated by the N3 pole, so that the magnetic brush is formed. Thus, an amount of developer provided on developer bearing member 22 may be controlled not only by the gap between the developer regulating member 25 and the rotating sleeve 22a but also by the magnetic field generated therebetween.

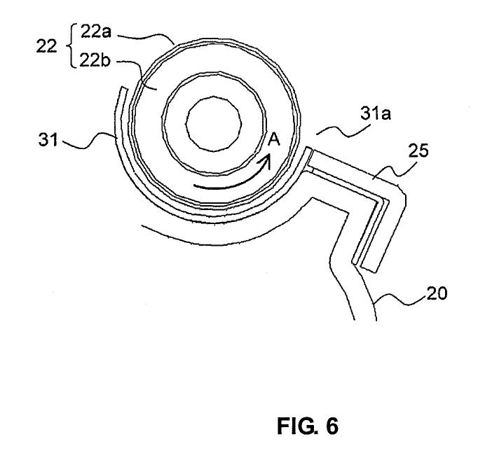

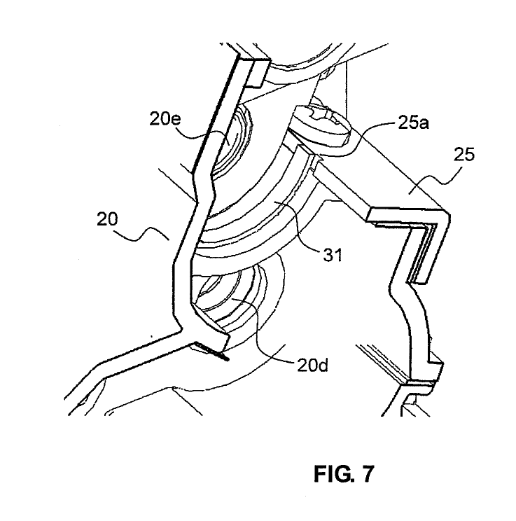

FIG. 6 is a sectional view of a developer bearing member and a developer regulating member 25 included in the developing device at one end of the developing device in the longitudinal direction thereof. FIG. 7 is a sectional perspective view of a section around an end of the developer regulating member viewed from the inside of the developing device. In FIGS. 6 and 7, the developing device is viewed in a direction opposite to the direction in which the developing device is viewed in FIG. 5. Therefore, in FIGS. 6 and 7, the developer regulating member 25 is on the right side of the developer bearing member 22. In addition, for convenience of explanation, the second mixing screw 21b and the developer bearing member 22 are not shown in FIG. 7. The developer bearing member 22 and the developer regulating member 25 have similar sealing structures at either end thereof. Therefore, only the sealing structure at one end thereof will be described herein.

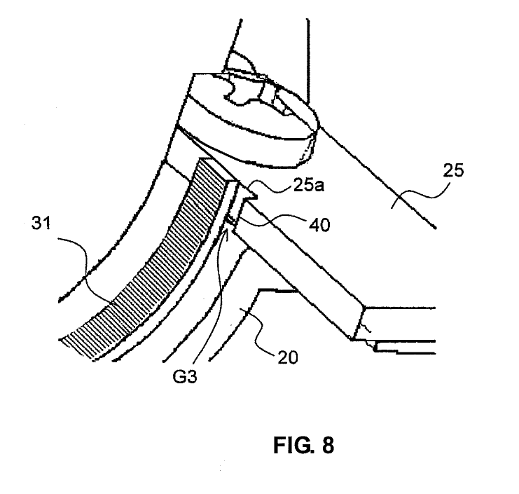

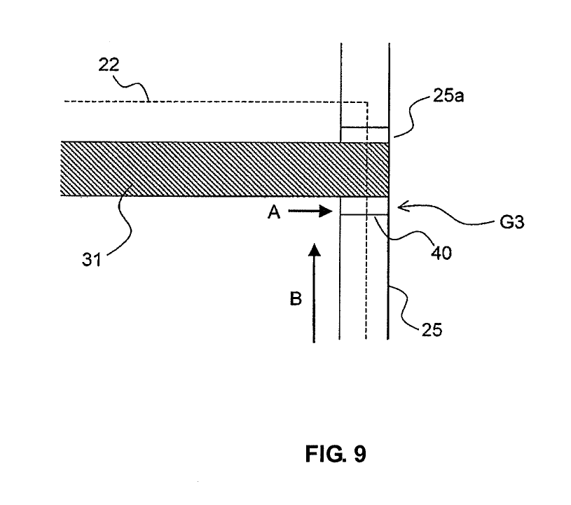

As shown in FIGS. 6 and 7, bearing hole 20d for supporting second mixing screw 21b in a rotatable manner and bearing hole 20e for supporting developer bearing member 22 in a rotatable manner are formed in developer container 20. Developer container 20 has an arc-shaped portion on an inner surface thereof, and the arc-shaped portion has an arc shape that is concentric with bearing hole 20e. A band-shaped magnetic sealing member 31 is provided on the arc-shaped portion of developer container 20. The magnetic sealing member 31 may extend along the outer peripheral surface of rotating sleeve 22a of developer bearing member 22 with a predetermined gap provided between magnetic sealing member 31 and rotating sleeve 22a. In some embodiments, an end face of the developer regulating member may include one or more cut portions. For example, as shown in FIGS. 7-8 cut portion 25a is formed in an end face of the developer regulating member 25, which faces the developer bearing member 22. FIG. 9 depicts magnetic sealing member 31 extending to come in contact with the cut portion 25a from the upstream side in the rotational direction of the developer bearing member 22 (direction shown by the arrow A).

In some embodiments, this structure described in FIGS. 7-9 may allow the sealing effect of the magnetic sealing member 31 to be obtained at a position downstream of the developer regulating member 25. Thus, leakage of the developer through an area where the developer regulating member 25 and the magnetic sealing member 31 are near each other may be inhibited. As shown in FIG. 8, some embodiments may include an auxiliary sealing member 105.

In some embodiments, use of the structure defined in FIGS. 7 and 9 may render use of an auxiliary sealing member unnecessary. Therefore, a number of components and the number of manufacturing steps may be reduced. In the process of attaching the developer regulating member 25, the developer regulating member 25 may be positioned such that the magnetic sealing member 31 passes through the cut portion 25a. Thus, a clearance may be provided between the developer bearing member 22 and the magnetic sealing member 31, and the magnetic sealing member 31 may be arranged so as to extend to a position downstream of the developer regulating member 25.

Magnetic sealing members may be from various materials including, but not limited to a permanent magnet, a ferromagnetic material, such as iron, nickel, cobalt, and alloys thereof, and/or any other material capable of being magnetized. In some embodiments, magnetic sealing member 31 may be comprised of, for example, a permanent magnet. In an embodiment, a magnetic sealing member may not be a magnet. In order to obtain sufficient sealing effect prevented from the leakage of the developer on the magnetic brush, where the magnetic sealing member 31 is not a magnet, the magnet member 22b may extend to the end of the developer bearing member 22 so that the magnetic sealing member 31 is positioned near the magnet member 22b.

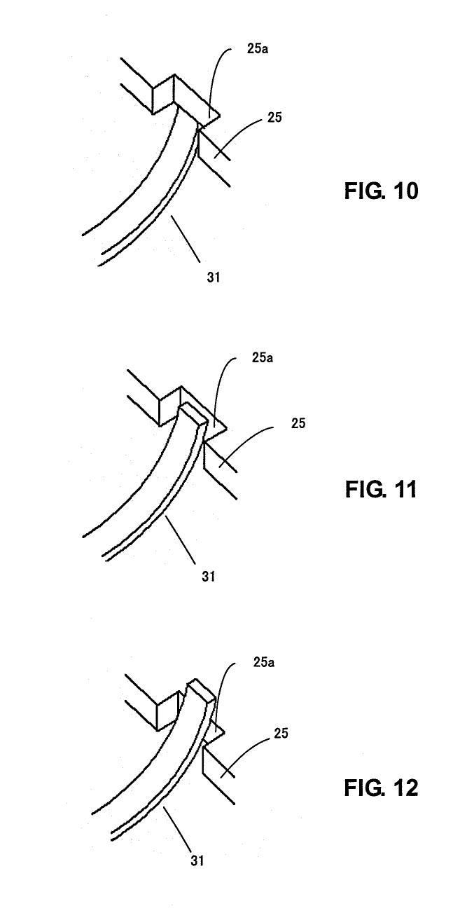

Magnetic sealing members may be positioned such that an end portion of the magnetic sealing member is positioned proximate the cut portion of developing regulating member. As shown in FIG. 10, magnetic sealing member 31 may be positioned such that an end of the magnetic sealing member contacts cut portion 25a of developing regulating member 25. In an embodiment depicted in FIG. 11 magnetic sealing member 31 may be positioned such that an end portion of the magnetic sealing member extends into cut portion 25a of developing regulating member 25. Further, some embodiments as shown in FIG. 12 may include magnetic sealing member 31 which extends through cut portion 25a extending beyond an upper surface of developing regulating member 25.

In an embodiment, an end of the magnetic sealing member may be positioned proximate a cut portion of developer regulating member. Additionally, the magnetic sealing member may extend to come in contact with the cut portion from an upstream side in a rotational direction of the developer bearing member. For example, an undersurface of the magnetic sealing member may be in contact with an upper surface of the cut portion and/or extend through the cut portion from an upstream side in a rotational direction of the developer bearing member.

FIG. 8 depicts an enlarged view of a section around the end the magnetic sealing member shown in FIG. 7. As shown in FIG. 8, the width of the cut portion 25a may be larger than that of the magnetic sealing member 31, and a gap G3 may be formed between the magnetic sealing member 31 and an inner side edge 40 of the cut portion 25a. The position of gap G3 may be determined in consideration of the attachment position of the magnetic sealing member 31, the dimensions of the developer regulating member 25, the position at which the cut portion 25a is formed, etc. This may inhibit the magnetic sealing member 31 from interfering with the coupling of the developer regulating member 25.

As shown in FIG. 9, the direction in which the developer moves from the central area of the developer bearing member 22 to the end thereof (direction shown by the arrow B) and the direction in which the magnetic sealing member extends (direction shown by the arrow A) are perpendicular to each other. Therefore, the developer which moves in the direction shown by the arrow B from the central area of the developer bearing member 22 to the end thereof is blocked by the magnetic sealing member 31, and then moves in the direction shown by the arrow A. Thus, magnetic sealing member 31 reduces the pressure of the developer which moves toward gap G3.

In some embodiments, magnetic sealing member 31 may overlap cut portion 25a. Gap G3 may be filled with the magnetic brush formed between the magnetic sealing member 31 and the developer bearing member 22. Thus, the sealing effect of the magnetic sealing member 31 may occur in the gap G3, and therefore the developer may be inhibited from leaking through the gap G3. In an embodiment where the developer regulating member 25 is made of a magnetic body and the magnetic sealing member 31 is made of a magnet, a magnetic field between the developer regulating member 25 and the magnetic sealing member 31 may be generated in gap G3. Therefore, the leakage of the developer may be inhibited. Proper dimensioning of gap G3 may affect a seal formed using the magnetic sealing member.

Various modifications of the above-described embodiments are possible within the scope of the present invention. For example, the developing device is not limited to the developing device shown in FIGS. 4-12. Embodiments may include various kinds of developing devices using single-component magnetic developer or two-component developer including a toner component and magnetic carrier.

The sealing structure described in the above-described embodiment is provided in the developing device including the developer bearing member 22 and the developing roller 23, and is disposed at each end of the developer bearing member 22 and the developer regulating member 25 in the longitudinal direction thereof. In an embodiment, the sealing structure may be provided in a developing device in which the developer bearing member 22 and the photosensitive drum 1 are disposed so as to face each other. Thus, a sealing structure may be used in embodiments without the developing roller.

An embodiment may include a developing device having a housing which houses magnetic developer; a developer bearing member which is rotatably supported by the housing and which holds the developer with a magnet member disposed in the developer bearing member; a developer regulating member which extends along a longitudinal direction of the developer bearing member, the developer regulating member having a cut portion at each end thereof in a surface which faces the developer bearing member and regulating an amount of the developer held on the developer bearing member; and a magnetic sealing member which extends along an outer peripheral surface of the developer bearing member at each end of the developer bearing member in the longitudinal direction thereof and extends to the cut portion from an upstream side in a rotational direction of the developer bearing member.

In addition, some embodiments of the developer regulating member may include a magnetic body.

An embodiment provides an image forming apparatus having the developing device described herein. Having thus described in detail preferred embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. A developing device comprising:
a housing configured to store magnetic developer;
a developer bearing member supported by the housing comprising a magnet member disposed in the developer bearing member, wherein the developer bearing member rotates within the housing;
a developer regulating member positioned substantially parallel to the developer bearing member, having one or more cut portions configured to regulate an amount of the developer held on the developer bearing member; and
one or more magnetic sealing members which extend along an outer peripheral surface of the developer bearing member positioned proximate an end portion of the developer bearing member wherein a portion of the magnetic sealing member is positioned substantially within the cut portion of the developer regulating member.

2. The developing device according to claim 1, wherein the one or more magnetic sealing members comprise two magnetic sealing members positioned at a first end portion and a second end portion of the developer bearing member.

3. The developing device according to claim 1, wherein the one or more cut portions are positioned to substantially face the developer bearing member.

4. The developing device according to claim 1, wherein a primary direction in which the developer is moved by the developer bearing member and a direction in which the magnetic sealing member extends are perpendicular to each other.

5. The developing device according to claim 1, wherein a width of the magnetic sealing member is smaller than a width of the cut portion.

6. The developing device according to claim 1, wherein the developer regulating member includes a magnetic body.

7. The developing device according to claim 1, wherein a surface of the magnetic sealing member is positioned proximate a surface of the cut portion from an upstream side in the rotational direction of the developer bearing member.

8. The developing device according to claim 1, wherein the magnetic sealing member extends through the cut portion from an upstream side in a rotational direction of the developer bearing member.

9. The developing device according to claim 1, wherein the magnetic sealing member extends through the cut portion from an upstream side to extend beyond a downstream surface of the developer regulating member.

10. An image forming apparatus comprising:
an image bearing member;
a charging device which charges the image bearing member uniformly;
an exposure unit which exposes the image bearing member based on image information;
a fixing unit which fixes a toner on a recording medium; and
a developing device comprising:
a housing comprising magnetic developer;
a developer bearing member which is rotatably supported by the housing and is configured to hold the developer with a magnet member disposed in the developer bearing member;
a developer regulating member which extends along a longitudinal direction of the developer bearing member, having a cut portion at each end portion of the developer regulating member in a surface facing the developer bearing member; and
a magnetic sealing member which extends along an outer peripheral of the developer bearing member at each end portions of the developer bearing member in the longitudinal direction thereof, extends to come in contact with the cut portion from an upstream side in a rotational direction of the developer bearing member.

11. An image forming apparatus according to claim 10, wherein a width of the magnetic sealing member is smaller than a width of the cut portion.

12. An image forming apparatus according to claim 10, wherein the developer regulating member includes a magnetic body.

13. An image forming apparatus according to claim 10, wherein the developer regulating member is configured to regulate an amount of the developer held on the developer bearing member.

14. An image forming apparatus according to claim 10, wherein a undersurface of the magnetic sealing member contacts with a upper surface of the cut portion from an upstream side in the rotational direction of the developer bearing member.

15. An image forming apparatus according to claim 10, wherein the magnetic sealing member extends through the cut portion from an upstream side in a rotational direction of the developer bearing member.

16. A method of inhibiting leakage of the developer during a printing process, comprising:
providing one or more magnetic sealing members at an end of a developing device;
providing a magnet member in a developer bearing member proximate the magnetic sealing member;
providing developer to a surface of the developer bearing member; and
allowing a magnetic field to form between the magnetic sealing member and the magnet member such that a magnetic field inhibits movement of the developer beyond a plane corresponding to the edge of the magnetic sealing member.

17. The method of claim 16 wherein the one or more magnetic sealing members are positioned within one or more cut portions of a developer regulating member.

18. The method of claim 16, wherein the one or more magnetic sealing members move freely within the cut portion developer regulating member.

19. The method of claim 16 wherein the one or more magnetic sealing members comprise two magnetic sealing members positioned at a first end and a second end of the developer bearing member.

20. A developing device comprising:
a housing comprising a magnetic developer;
a developer bearing member configured to hold the developer with a magnet member;
a developer regulating member extending along a longitudinal direction of the developer bearing member, having a cut portion at an end portion; and
a magnetic sealing member extending along an outer peripheral surface of the developer bearing member configured to be positioned proximate the cut portion such that the magnetic sealing member rotates freely in a rotational direction of the developer bearing member within at least a portion of the cut portion.
